(19) United States
(12) Patent Application Publication
(10) Pub. No.: US 2024/0354927 A1
(43) Pub. Date: Oct. 24, 2024

(54) OPERATION MONITORING METHOD

(71) Applicant: TOYOTA JIDOSHA KABUSHIKI KAISHA, Toyota-shi (JP)

(72) Inventors: Yuta TSUBAKI, Toyota-shi (JP); Akira NUMASATO, Nagoya-shi (JP); Yuhei KOSAKA, Toyota-shi (JP); Yuta OHAMA, Toyota-shi (JP)

(73) Assignee: TOYOTA JIDOSHA KABUSHIKI KAISHA, Toyota-shi (JP)

(21) Appl. No.: 18/586,917

(22) Filed: Feb. 26, 2024

(30) Foreign Application Priority Data
Apr. 24, 2023 (JP) 2023-071115

(51) Int. Cl. G06T 7/00

(52) U.S. Cl. CPC G06T 7/0004; G06T 2207/10016; G06T 2207/30164; G06T 2207/30232

(57) ABSTRACT

The operation monitoring method includes the steps of determining whether or not the operator is performing a predetermined action on a workpiece, and performing quality determination of the workpiece when it is determined that the operator is performing the predetermined action.

### FIELD

The present disclosure relates to an operation monitoring method.

### BACKGROUND

When a product is manufactured manually, a predetermined operation on a workpiece is performed by an operator in each manufacturing process. In order to improve the quality of the product, it is desirable to be able to detect an inappropriate operation by monitoring the operation by the operator.

In the information processing system described in Patent Literature 1, a correlation between an action of an operator who performs an operation on a workpiece and an inspection result of the appearance of the workpiece after the work is estimated, and the estimated correlation is fed back to the operator.

### CITATIONS LIST

### Patent Literature

[PTL 1] Japanese Unexamined Patent Publication No. 2022-155848

### SUMMARY

### Technical Problem

However, in the above-described method, since the appropriateness of the action of the operator is determined based on the inspection result of the appearance of the workpiece, an inappropriate action (for example, an inefficient action or a dangerous action) of the operator is overlooked as long as a problem does not occur in the appearance of the workpiece. In addition, in a case where the operator performs a plurality of actions, since the appropriate state of the workpiece after operation differs for each of the actions, it is difficult to perform the quality determination of the workpiece without specifying the content of the operation. Therefore, there is room for improvement in a method of monitoring an operation performed by an operator.

Therefore, in view of the above problem, an object of the present disclosure is to determine the appropriateness of an operation performed by an operator with higher accuracy.

### Solution to Problem

The summary of the present disclosure is as follows.

(1) An operation monitoring method for monitoring an operation performed by an operator, comprising the steps of: determining whether or not the operator is performing a predetermined action on a workpiece; and performing quality determination of the workpiece when it is determined that the operator is performing the predetermined action.

(2) The operation monitoring method described in above (1), wherein the quality determination of the workpiece is performed based on an image of the workpiece generated by a camera attached to the operator so as to capture the workpiece.

(3) The operation monitoring method described in above (1) or (2), wherein the quality determination of the workpiece is performed based on a moving image obtained by capturing the workpiece.

(4) The operation monitoring method described in above (3), wherein a length of the moving image is changed in accordance with a content of an operation being performed by the operator or a type of the workpiece.

(5) The operation monitoring method described in above (3), wherein the moving image is captured before and after a timing at which it is determined whether or not the operator is performing the predetermined action on the workpiece.

According to the present disclosure, it is possible to determine the appropriateness of an operation performed by an operator with higher accuracy.

### BRIEF DESCRIPTION OF DRAWINGS

FIG. 1 is a diagram schematically illustrating a configuration of an operation monitoring system according to an embodiment of the present disclosure.

FIG. 2 is a flow chart showing a control routine executed by the processor of the process PC to monitor the operation performed by the operator.

FIG. 3 is a diagram illustrating an example of coordinate data of a human skeleton.

### DESCRIPTION OF EMBODIMENTS

Hereinafter, embodiments of the present disclosure will be described in detail with reference to the drawings. In the following description, the same reference numerals are given to the same constituent elements.

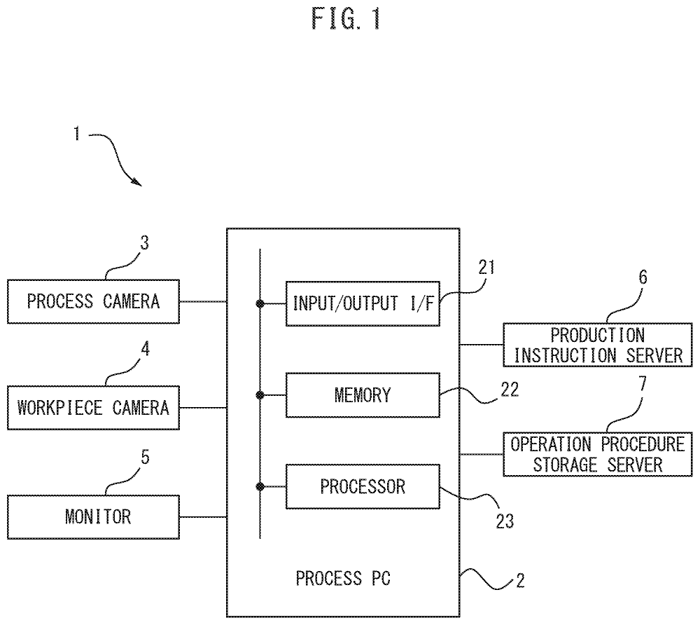

FIG. 1 is a diagram schematically illustrating a configuration of an operation monitoring system 1 according to an embodiment of the present disclosure. The operation monitoring system 1 is provided, for example, in a factory (such as an assembly factory of an automobile) for producing a product, and monitors an operation performed by an operator for producing a product. As shown in FIG. 1, the operation monitoring system 1 includes a process personal computer (PC) 2, a process camera 3, a workpiece camera 4, and a monitor 5.

The process PC 2 is an example of an operation monitoring device that monitors an operation performed by an operator. In the present embodiment, the process PC 2 detects an inappropriate operation by an operator in the manufacturing process, and notifies the operator of the detected result. As shown in FIG. 1, the process PC 2 includes an input/output interface 21, a memory 22, and a processor 23. The input/output interface 21 and the memory 22 are connected to the processor 23 via signal lines.

The input/output interface 21 has interface circuitry for connecting the process PC 2 and the peripheral device. The output of the peripheral device such as the process camera 3 and the workpiece camera 4 is input to the process PC 2 via the input/output interface 21, and the command signal generated by the processor 23 is output to the peripheral device such as the monitor 5 via the input/output interface 21.

The memory 22 includes, for example, a volatile semiconductor memory and a non-volatile semiconductor memory. The memory 22 stores computer programs, data, and the like used when various kinds of processing are executed by the processor 23.

The processor 23 comprises one or more CPU (Central Processing Unit) and its peripheral circuitry. The processor 23 may further include an arithmetic circuit such as a logical arithmetic unit or a numerical arithmetic unit.

The process camera 3 is provided at a predetermined position (for example, on a ceiling, a column, or the like) of the factory so as to capture an operator in the manufacturing process. The process camera 3 captures an overhead view of the operator and generates an image of the operator. The process camera 3 is connected to the process PC 2 by wire or wirelessly, and the output of the process camera 3, that is, the image generated by the process camera 3, is transmitted to the process PC 2. In the present embodiment, the process camera 3 captures a moving image of the operator and generates a moving image of the operator as an image of the operator.

The workpiece camera 4 is provided in a factory so as to capture a workpiece (for example, a vehicle component, etc.) to which an operation by an operator is applied. In the present embodiment, the work camera 4 is mounted on the head (for example, the forehead) of the operator so as to capture the workpiece from the same viewpoint as the operator. The workpiece camera 4 may be attached to another part of the operator such as the neck. The workpiece camera 4 is connected to the process PC 2 by wire or wirelessly, and the output of the workpiece camera 4, that is, the images generated by the workpiece camera 4 are transmitted to the process PC 2. In the present embodiment, the workpiece camera 4 captures a moving image of a work and generates a moving image of the work as an image of the work.

The monitor 5 has a display for displaying information, and is provided in the vicinity of the operator so as to be visually recognized by the operator. The monitor 5 is connected to the process PC 2 by wire or wirelessly, and displays information presented to the operator in response to the output from the process PC 2.

In addition, the production instruction server 6 and the operation procedure storage server 7 are connected to the process PC 2, and transmit predetermined data to the process PC 2. The production instruction server 6 is provided in a factory, for example, stores information about the production instruction of products to be produced in the factory (e.g., type of product, model number, lot number, production number, etc.). The operation procedure storage server 7 is provided in a factory, for example, and stores an operation procedure manual describing an operation procedure performed by an operator. The production instruction server 6 and the operation procedure storage server 7 may be integrated and configured as a single server. Further, the production instruction server 6 and the operation procedure storage server 7 may be omitted, and the data stored by the production instruction server 6 and the operation procedure storage server 7 may be stored in the memory 22 of the process PC 2.

The operation monitoring method according to the present embodiment is executed by a computer, and in the present embodiment, is executed by the processor 23 of the process PC 2. In the case where a defect occurs in a workpiece operated by an operator, it is desirable to notify the operator of the occurrence of the defect and urge the operator to correct the workpiece. In addition, even if a defect does not occur in the workpiece operated by the operator, when the action by the operator is inappropriate, there is a possibility that the production efficiency of the product is lowered. Further, in the case where the operator performs a plurality of actions, since the appropriate state of the workpiece after the operation is different for each of the actions, it is difficult to perform the quality determination of the workpiece without specifying the content of the operation.

Therefore, in the present embodiment, the processor 23 of the process PC 2 determines whether or not the work by the operator is appropriate based on the operation of the operator who performs the work on the work and the state of the work that is performed by the operator. The operation of the operator is acquired by the process camera 3, and the state of the work is acquired by the workpiece camera 4. For this reason, the processor 23 determines whether or not the work by the operator is appropriate based on the output of the process camera 3 and the output of the workpiece camera 4.

Specifically, the processor 23 determines whether or not the operator is performing a predetermined action on the workpiece based on the output of the process camera 3, and performs quality determination of the workpiece based on the output of the workpiece camera 4 when it is determined that the operator is performing the predetermined action. That is, the operation monitoring method according to the present embodiment includes a step of determining whether or not an operator is performing a predetermined action on a workpiece, and a step of performing quality determination of the workpiece when it is determined that the operator is performing the predetermined action. According to the above-described method, since the appropriateness of the operation is determined in consideration of the action of the operator in addition to the state of the workpiece, it is possible to more accurately determine the appropriateness of the operation. Further, even when the operator performs a plurality of actions according to the operation procedure manual, it is possible to identify the operation to be monitored based on the action of the operator, and thus it is possible to more accurately determine the quality determination of the workpiece.

In addition, the processor 23 notifies the operator of a warning when it is determined that the operator is not performing a predetermined action on the workpiece. As a result, it is possible to encourage the operator to improve the action when the operator performs an inappropriate action.

The processor 23 notifies the operator of the result of the quality determination of the workpiece. As a result, it is possible to prevent the operator from continuing the operation without noticing the defect of the workpiece. In addition, when a defect occurs in the workpiece, it is possible to perform an operation for correcting the workpiece before the workpiece flows to the subsequent process.

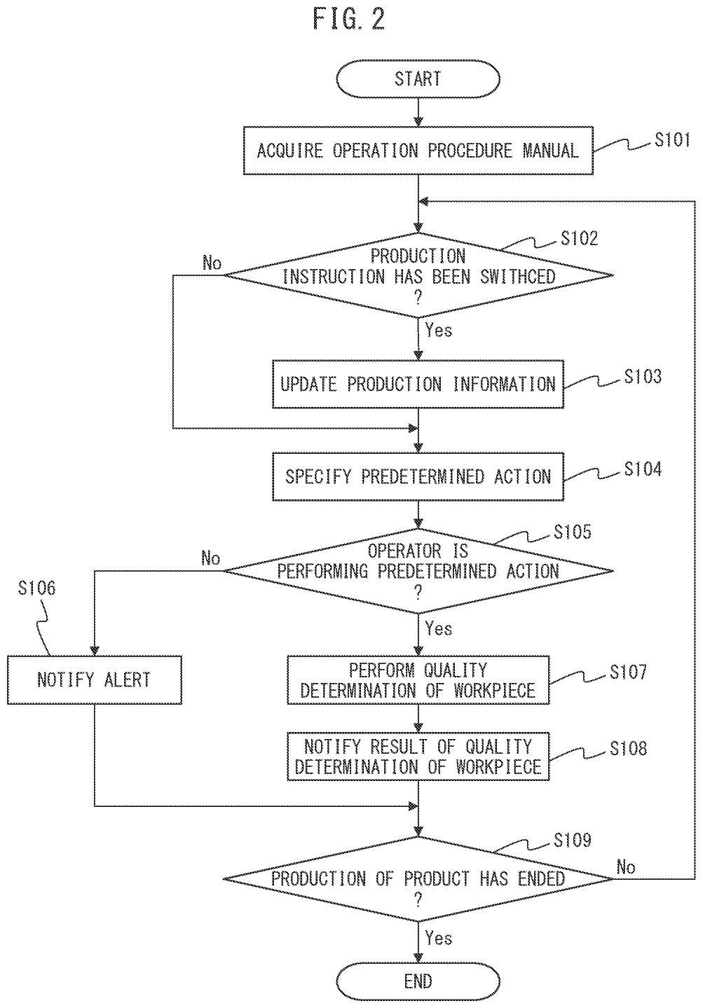

FIG. 2 is a flow chart illustrating a control routine executed by the processor 23 of the process PC 2 to monitor operations performed by an operator. This control routine is executed by the processor 23 when the production of the product is started in the manufacturing process. When a plurality of operators in the manufacturing process are monitored, the present control routine is executed for each of the plurality of operators.

First, in the step S101, the processor 23 acquires an operation procedure manual from the operation procedure storage server 7. For example, the operation procedure manual stored in the operation procedure storage server 7 is downloaded to the memory 22 of the process PC 2. In a case where a plurality of products having different operation procedures are handled by the operator to be monitored, the processor 23 acquires the operation procedure manuals for all products.

Then, in the step S102, the processor 23 determines whether or not the production instruction has been switched. For example, when the type of the product flowing through the manufacturing process is changed, the production instruction server 6 transmits a new production instruction to the process PC 2, and the processor 23 determines that the production instruction has been switched when a new production instruction is received from the production instruction server 6.

If it is determined in the step S102 that the production instruction has been switched, the present control routine proceeds to step S103. In the step S103, the processor 23 updates the production information. For example, the processor 23 extracts an operation procedure manual corresponding to a new production instruction, and updates the operation procedure manual to be referred to in order to identify the action of the operator. In the step S101, only the operation procedure manual for the product to be produced may be acquired, and in the step S103, the processor 23 may acquire the operation procedure manual corresponding to the new production instruction from the operation procedure storage server 7. On the other hand, if it is determined in step S102 that the production instruction has not been switched, the control routine skips the step S103 and proceeds to the step S104.

In the step S104, the processor 23 specifies a predetermined action to be performed by the operator based on the description of the operation procedure manual. For example, in a case where the operation to be monitored determined from the operation procedure manual is the tightening of the torque wrench, an action of rotating the torque wrench is specified as a predetermined action. In a case where the operation to be monitored determined from the operation procedure manual is the fitting operation of the grommet seal, an action of fitting the grommet seal (for example, an action of pushing a hand toward the vehicle) is specified as a predetermined action. In a case where the operation to be monitored determined from the operation procedure manual is an assembling operation of a component, an action of assembling the component to the workpiece is specified as a predetermined action. When the operation to be monitored determined from the operation procedure manual is spot welding, an action of pulling the hand backward after the spot welding is specified as a predetermined action.

In addition, when the operator performs a plurality of actions, the processor 23 specifies a predetermined action to be performed by the operator based on the order of the operations described in the operation procedure manual. That is, the processor 23 specifies a predetermined action to be performed by the operator in consideration of the previous action of the operator. Note that in a case where the operation procedure manual includes information on the operation time of each operation, the processor 23 may specify a predetermined action to be performed by the operator based on the operation time.

Next, in the step S105, the processor 23 determines whether or not the operator is performing a predetermined action based on the image of the operator generated by the process camera 3. In the present embodiment, the process camera 3 constantly captures an image of the operator and periodically transmits a moving image of the operator to the process PC 2.

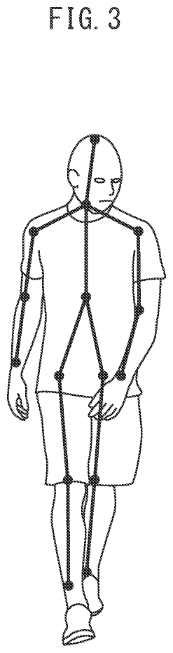

For example, the processor 23 determines whether or not the operator performs a predetermined action using a detector learned in advance so as to detect the skeleton of the operator from the image data of the operator. Such a detector detects feature points such as human joints using a machine learning model such as deep learning to detect coordinate data of a human skeleton. FIG. 3 is a diagram showing an example of a human skeleton. In FIG. 3, a black circle indicates a coordinate point of a feature point, and a skeleton of a human is indicated by a combination of a plurality of coordinate points. The processor 23 specifies the action of the operator based on the coordinate data of the skeleton of the operator, and compares the action of the operator with the predetermined action to determine whether or not the operator is performing the predetermined action.

If it is determined in step S105 that the operator is not performing the predetermined action, the control routine proceeds to step S106. In the step S106, the processor 23 notifies the operator of an alert via the monitor 5. For example, the processor 23 displays, on the monitor 5, a character or an image indicating that the action of the operator is inappropriate. It should be noted that the processor 23 may notify the operator of an audible warning such as a buzzer sound or voice sound instead of or in addition to a visual warning.

On the other hand, if it is determined in step S105 that the operator is performing a predetermined action, the control routine proceeds to step S107. In the step S107, the processor 23 performs quality determination of the workpiece operated by the operator based on the image of the workpiece generated by the workpiece camera 4. In the present embodiment, the workpiece camera 4 constantly captures a workpiece and periodically transmits a moving image of the workpiece to the process PC 2.

For example, the processor 23 performs quality determination of the workpiece operated by the operator by using a discriminator learned in advance so as to output the result of the quality determination of the workpiece from the image data of the workpiece. The Example of such an discriminator include a machine learning model such as neural network, a support vector machine, a random forest, and the like.

In the present embodiment, the quality determination of the workpiece is performed on the basis of an image of the workpiece generated by the workpiece camera 4 attached to the operator so as to capture the workpiece. Therefore, it is possible to obtain a clear image of the workpiece without hindering the operation by the operator, and it is possible to improve the accuracy of the quality determination of the workpiece.

Further, in the present embodiment, the quality determination of the workpiece is performed based on a moving image obtained by capturing the workpiece. Therefore, the quality determination of the workpiece can be performed in consideration of the time-series change of the workpiece when the operation is performed by the operator, and the accuracy of the quality determination of the workpiece can be improved. In this case, the time-series image data of the workpiece is input to the discriminator.

Note that the length of the moving image obtained by capturing the workpiece may be changed in accordance with the content of the operation being performed by the operator or the type of the workpiece. As a result, it is possible to perform quality determination of the workpiece by using a moving image having a length suitable for the content of the operation or the type of the workpiece, and thus it is possible to improve the accuracy of the quality determination of the workpiece. The content of the operation is specified from the work procedure manual, and the type of the workpiece is specified from the information on the production instruction.

Further, in the present embodiment, the moving image of the workpiece is captured before and after the timing at which it is determined whether or not the operator is performing a predetermined action on the workpiece. In other words, the moving image of the workpiece is captured across a timing at which it is determined whether or not the operator is performing a predetermined action on the workpiece. Therefore, regardless of the timing at which the appropriateness of the operation is determined, the quality determination of the workpiece can be performed using an image captured at a timing suitable for the quality determination of the workpiece, and the accuracy of the quality determination of the workpiece can be improved.

After the step S107, in the step S108, the processor 23 notifies the operator of the result of the quality determination of the workpiece through the monitor 5. For example, the processor 23 displays, on the monitor 5, a character or an image indicating a result of the quality determination of the workpiece. The processor 23 may notify the operator of a buzzer sound or voice sound indicating the result of the quality determination of the workpiece. In addition, the processor 23 may notify the operator of at least one of a visual warning and an audible warning only when the result of the workpiece quality determination is defective.

After the step S106 or the step S108, the control routine proceeds to the step S109. In the step S109, the processor 23 determines whether the production of the product has ended. For example, when the production of the product ends, a production end notification is transmitted from the production instruction server 6 to the process PC 2. If it is determined in the step S109 that production of the product has ended, the present control routine ends. On the other hand, if it is determined that the production of the product has not ended, the control routine returns to the step S102, and the steps S102 to S108 are repeatedly executed until the determination of the step S109 is affirmative.

When the operator to be monitored performs the same operation at all times, the steps S101 to S104 may be omitted.

While preferred embodiments of the present disclosure have been described above, the present disclosure is not limited to these embodiments, and various modifications and changes can be made within the scope of the claims. For example, the workpiece camera 4 may be provided in the vicinity of the operator so as to capture a workpiece to be operated by the operator.

In addition, the process camera 3 may be omitted, and a motion sensor that detects a human motion may be attached to the operator. In this case, the processor 23 of the process PC 2 determines whether or not the operator is performing a predetermined action on the workpiece based on the output of the motion sensor.

In addition, the workpiece camera 4 and the monitor 5 may be integrally configured and worn by an operator as a wearable device (for example, a smart glass such as a MR (Mixed Reality) glass).

In addition, the process PC 2 may be provided outside the plant by wirelessly transmitting information between the process PC 2 and the surrounding device. Further, the operation monitoring method according to the present embodiment may be performed to monitor an operation performed by an operator in a facility such as a logistics facility.

### REFERENCE SIGNS LIST

2 Process PC
23 Processor
3 Process camera
4 Work camera

1. An operation monitoring method for monitoring an operation performed by an operator, comprising the steps of:
determining whether or not the operator is performing a predetermined action on a workpiece; and
performing quality determination of the workpiece when it is determined that the operator is performing the predetermined action.

2. The operation monitoring method according to claim 1, wherein the quality determination of the workpiece is performed based on an image of the workpiece generated by a camera attached to the operator so as to capture the workpiece.

3. The operation monitoring method according to claim 1, wherein the quality determination of the workpiece is performed based on a moving image obtained by capturing the workpiece.

4. The operation monitoring method according to claim 3, wherein a length of the moving image is changed in accordance with a content of an operation being performed by the operator or a type of the workpiece.

5. The operation monitoring method according to claim 3, wherein the moving image is captured before and after a timing at which it is determined whether or not the operator is performing the predetermined action on the workpiece.
